(19) United States
(12) Patent Application Publication
(10) Pub. No.: US 2006/0130077 A1
(43) Pub. Date: Jun. 15, 2006

(54) Recording device with loading means status indication and method for recording using the loading means status

(75) Inventors: Robert Albertus Brondijk, Eindhoven (NL); Stephanus Josephus Maria Van Beckhoven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philps Electronics N.V., Eindhoven (NL)

(21) Appl. No.: 10/559,560

(22) PCT Filed: May 25, 2004
(86) PCT No.: PCT/IB04/50772

§ 371 Date: Dec. 2, 2005

(30) Foreign Application Priority Data
Jun. 5, 2003 (EP) 03102629.8

(51) Int. Cl. G11B 33/02

(52) U.S. Cl. 720/600

(57) ABSTRACT

A recording device with loading means for loading a single record carrier comprises means for detecting not only that the loading means has reached its end position but also provides information that the loading means is currently loading or unloading the recording medium. This allows the recording device to start actions while the loading means is operating to prepare for the completion of the loading operation. A progress indication of the loading operation allows even better timing of actions by the recording device. A recording device may start filling a buffer once a certain progress of the loading operation is reached and the buffer size is sufficient to bridge the remaining duration of the loading operation. Thus the loss of information to be recorded is reduced.

The invention relates to a recording device comprising a loading means to load a recording medium and comprising loading means status determining means for determining a loading means status, and a method for recording information on a recording medium comprising the steps of inserting the recording medium in a loading means, operating the loading means and starting a recording operation.

Such a recording device and method is known from the working draft NCITS T10/1363-D revision 10g SCSI Multimedia Commands-3(MMC-3) that describes commands for recording devices with removable recording media for instance tapes or optical disc.

Before the recording can commence the loading operation and the initialization or calibration of the recording device and the recording medium must be completed.

The completion of the loading operation is indicated by a loading means status that can report tray open and tray closed.

The disadvantage of such a recording device is that it introduces a delay between the start of the loading operation and the start of the recording operation that users of these devices dislike.

It is an objective of the invention to reduce the delay between the start of the loading operation and the start of the recording operation.

This objective is achieved in that the recording device of the invention is characterized in that the loading means status determining means are operative to detect a loading means status representing a loading means operation of loading the recording medium.

The detection of the status of the actual loading operation allows the recording device to start preparing for the start of the recording. Thus the recording device does not need to wait for confirmation of the completion of the loading process before preparing for the start of the recording. Thus a reduction of the delay between the start of the loading operation and the start of the recording operation is achieved.

A further embodiment is characterized in that the loading means status comprises a progress indicator.

When the recording device knows how far along the loading operation has progressed it can start the preparations for the start of the recording at the appropriate time ensuring that all preparations are completed when the actual recording can start.

When multiple preparations are required the recording device can start the preparations at the appropriate time to ensure not all preparations start at the same time, thus saving resources in the recording device. Alternatively each preparation can be started at the last possible moment ensuring they are all completed when the loading operation is completed, reducing the delay between the start of the loading operation and the start of the recording operation.

A further embodiment is characterized in that the progress indicator indicates a time duration until the loading means loading operation is complete.

Besides a percentage indicator a time indication may be very useful. The recording device may for instance learn from previous loading operations how long it will take to complete the loading operation and can more accurately predict the remaining duration of the loading operation. Since the loading operation is performed by a mechanical device the actual duration loading operations may vary widely from recording device to recording device. Since the recording device then knows the actual duration of the loading operation of its own loading means there is no need for engineering fixed safety margins into the recording device to ensure all recording devices from a production series have completed the preparations before the actual recording starts. Thus a per device reduction of the delay between the start of the loading operation and the start of the recording operation is achieved.

A further embodiment is characterized in that the recording device is operative to start a recording operation when a loading means status representing the loading means operation of loading the recording medium is detected.

As soon as the actual loading operation is detected the time until the recording medium is loaded and available for recording can be predicted, thus allowing the appropriate scheduling of preparations for the start of recording.

A further embodiment is characterized in that the recording device is operative to start a recording operation when the progress indicator associated with the loading means status representing the loading means operation of loading the recording medium reaches a predetermined value.

The recording device knows how much time it needs to prepare for the start of the recording. The recorder can thus start its actions at the moment when the progress indicator reaches a certain value.

A further embodiment is characterized in that the recording device further comprises a buffer with a buffer size and that the predetermined value of the progress indicator is determined by the buffer size.

One of the preparations the recorder can take before the actual recording on the recording medium starts is to store the information to be recorded in a buffer. The buffer has a buffer size that can store a certain amount of information. This certain amount of information corresponds to a duration for information that is a stream of information with a certain, possibly variable, bit rate.

It is thus possible for the recording device to start buffering the information for x seconds during the loading operation before the start of the recording operation on the recording medium because the recording device knows that it will certainly take less than x seconds before the loading operation is completed. The progress indication allow the recording device to determine how much more time is needed before the recording on the recording medium can commence and whether the buffer is large enough to buffer the information until the recording on the recording medium can commence.

Again, because there is a progress indicator the recording device can determine the remaining duration of the loading operation during the loading operation and does not need to determine the start of the loading operation and estimate the start of the recording operation based on typical loading operation durations. A reduction of the delay between the start of the loading operation and the start of the recording operation is thus achieved.

A further embodiment is characterized in that the recording device is a recording device for recording real time information.

The delay is especially harmful when recording real time information.

For instance when considering a Video Cassette Recorder it must be noted that when the user sees interesting real time information, for instance a TV program, and wants to record this program, he must insert a video tape (after having looked around for an empty one), wait until the loading operation is completed, the tape is extracted from the cassette and looped through the VCR drive and then press start Potentially valuable real time information is lost and cannot be retrieved.

It is clear that a real time stream, such a s a video stream, cannot be halted. Thus, in order to lose the least amount of data when a new recording medium is to be loaded into the recording device while the real time information is arriving the buffering should start as early as possible. The invention allows the earliest start of the recording and also the earliest start of buffering as explained above thus enabling the minimization of information lost when starting to record real time information. Given a buffer that can buffer the information during the loading operation no information is lost after the recording medium is placed in the loading means and the recording is initiated by pressing the record button or issuing the record command.

In addition, because of the availability of the progress indicator, the use of the buffer can be optimized to match the buffering capacity to the time required for the loading operation. The same amount of buffer can be used with loading means with varying loading durations. For instance a bit rate reduction can be performed on the incoming information when a recording device has a slower than average loader. The buffer is thus still sufficient to avoid the loss of information. When a recording device has a faster than average loader the spare buffer capacity can be used to buffer the information using a higher bit rate achieving higher quality.

A further embodiment is characterized in that the recording device is operative to abort a recording operation when the loading means status representing the blocked loading means is detected.

Once the loading operation commenced it is important to detect a blocked loading means.

This allows the buffering means to be adjusted, for instance by storing the information using a lower bit rate, to allow the user to correct the situation.

A further embodiment is characterized in that the recording device is operative to issue a warning on a display device.

Before the user can take a corrective action a warning must be issued either audible or on a display or by reporting a status ‘blocked loading means’ to a higher level application through a software or hardware interface.

The invention will now be discussed based on figures.

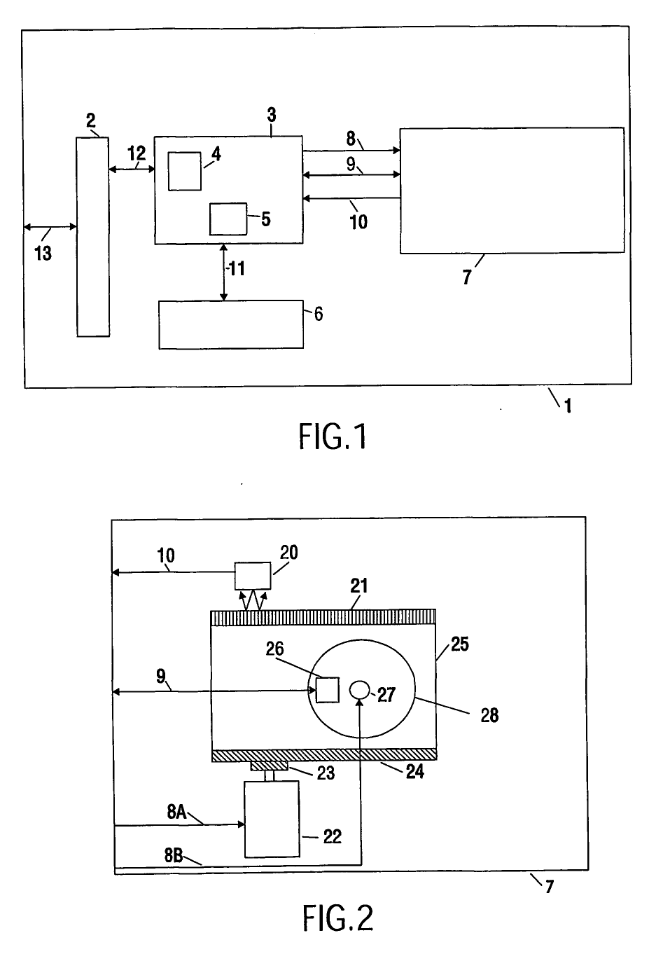

FIG. 1 shows a recording device.

FIG. 2 shows the mechanical drive mechanism.

FIG. 1 shows a recording device.

The recording device 1 comprises an interface 2 for communicating with other devices via an input/output 13. The recording device further comprises a processor 3 which comprises a status register 4 for reporting the loading means status and a buffer for temporarily storing incoming information before storing the information on the recording medium. The processor 3 communicates via a display interface 11 with a display and keyboard unit 6. This allows the recording device 1 to receive commands from a user, for instance the command ‘start recording’ and can display information regarding the recording process, for instance loading means status or warnings. It is evident that the receipt of commands and the reporting of the status can also be performed over the interface 2 to other devices connected to the recording device 1, for example a computer in case the recording device is a PC based recording device communicating with the computer over an IDE or SCSI interface. The processor 3 further controls a mechanical drive mechanism 7.

The Mechanical drive means comprises a loading means which is controlled via a first interface 8, recording means such as an optical pickup unit which is controlled via a bidirectional interface 9 for writing information on a recording medium, drive means for driving the recording medium which is controlled via the first interface 8 and loading means status determining means which are read out via a read-out interface 10.

When a command to start a loading means related operation, in this example recording, is received by the recording device 1, either via the interface 2 or the display and keyboard unit 6 the processor the processor 3 starts the operation of the loading means, for instance the loading of the recording medium. Via the read-out interface 10 the actual status of the loading means is read and the processor starts the preparations for recording. One of the preparations is to start filling the buffer 5 with information from the interface 2 ones the processor 3 is sure that the remianing time for the loading means to complete the loading operation is less than the amount of information received in that time that can be buffered in the buffer 5.

FIG. 2 shows the mechanical drive mechanism.

The mechanical drive mechanism 7 comprises a first motor 22 to operate the loading means. The first motor is connected via an axle to a gear 23 which drives a corresponding gear 24 mounted on the loading means 25. The first motor 22 can thus be controlled via an interface 8A in order to load or unload the recording medium. The loading means 25 comprise a position indicator 21 which allows a position determining means 20 the determination of the position of the loading means. The position indicator 21 and the position determining means 20 together form a position encoder where the position determining means 20 reports the status of the loading means via an interface 10.

The mechanical drive mechanism 7 further comprises an optical pickup 26 for writing to and reading from the recording medium via an interface 9 and a drive motor 27 to drive the recording medium, for instance a spindle motor driving the optical recording disc in a CD or DVD player. The position encoder can be implemented in various ways including optical sensors sensing the movement of a reflective strip with markings mounted on the loading means. Alternatively the first motor 22 can comprise an encoder that supplies information about the angular position of the motor axis thus allowing the determination of the loading means. In addition the optical pickup unit 26 can detect movement of the loading means when a strip with markings is positioned on the loading means such that movement of the loading means results in a corresponding movement of the strip in front of the optical pickup unit 26. If an absolute position indication is not required the strip with markings results in a detectable signal for the position determining means from which the position determining means can derive movement of the loading means and the direction of the loading means.

### IMPLEMENTATION IN THE COMMAND STRUCTURE OF AN RECORDING DEVICE

In the present command structure there are two locations where loading means status, i.e. tray status, information is provided. The first location is in the media status byte definition.

TABLE 1
Media Status Byte Definition

| | Bit | | | | | | | |
|---|---|---|---|---|---|---|---|---|
| Byte | 7 | 6 | 5 | 4 | 3 | 2 | 1 | 0 |

| | | | |
|---|---|---|---|
| 0 | Reserved | Media | Door or |
| | | Present | Tray open |

The Media Present status bit indicates if there is media present in the Logical Unit. A bit of 1 indicates that there is media present in the Logical Unit This bit is reported independently from the Door or Tray Open bit. If the Logical Unit does not support the capability of reporting the media state while the door or tray is open, it shall set this bit to zero when the door or tray is open.

Door or Tray Open bit indicates if the Tray or Door mechanism is in the open state. A bit of 1 indicates the door/tray is open.

The data returned, with a class code 110b, is defined in of the NCITS 10/1363-D working draft.

The second location where the loading means status is reported is in the mechanism status header as shown in table 3, accessible via the mechanism state command of table 1. Here the mechanism state field reports the state of the mechanism.

The Current Slot field (an 8-bit field) in the mechanism status header indicates the Current Slot selected for changers.

The lower 5 bits of Current Slot can be used as a progress indicator because for a loading means for a single recording medium the changer state fields are not needed. The MECHANISM STATUS Command (Table 2) requests that the recording device respond with the current status of the device. This command is intended to provide information to the Initiator about the current operational state of the Logical Unit. The recording device takes operational direction from both a host and the user. Movement of media in/out of the recording device as well as Play operation may be due to external controls or host commands. This command provides a method that allows the host to know what has transpired with the changer mechanism. The recording device is not a changer model.

TABLE 2
MECHANISM STATUS Command Descriptor Block

| | Bit | | | | | | | |
|---|---|---|---|---|---|---|---|---|
| Byte | 7 | 6 | 5 | 4 | 3 | 2 | 1 | 0 |

| 0 | Operation Code = 80h | | |
|---|---|---|---|
| 1-7 | Reserved | | |
| 8 | (MSB) | Allocation Length | |
| 9 | | | (LSB) |

| | |
|---|---|
| 10 | Reserved |
| 11 | Reserved (Control Byte) |

The ALLOCATION LENGTH field specifies the maximum length, in bytes, of the Mechanical Status Parameter list, see Table 3, that shall be transferred from the recording device to a host. The ALLOCATION LENGTH field of zero indicates that no data shall be transferred. This condition shall not be considered an error.

The CONTROL BYTE field shall be reserved. The recording device ignores this field.

The Mechanism Status Parameter list returned contains a header (Error! Reference source not found.) only. The recording device does not support the changer commands, then the number of slot tables returned to a host shall be zero.

TABLE 3
Mechanism Status Parameter List

Bit

| | | | | | | | | |
|---|---|---|---|---|---|---|---|---|
| Byte | 7 | 6 | 5 | 4 | 3 | 2 | 1 | 0 |

| | |
|---|---|
| 0-7 | Mechanism Status Header |

TABLE 4
Mechanism Status Header

| | Bit | | | | | | | |
|---|---|---|---|---|---|---|---|---|
| Byte | 7 | 6 | 5 | 4 | 3 | 2 | 1 | 0 |
| 0 | Fault | Changer | | Current Slot | | | | |
| | (0) | State = 0 | | (Low order 5 bits) = 0 | | | | |
| 1 | Mechanism | | | DoorOpen | Reserved = 0 | Current Slot | | |
| | State (111b) | | | | | (High order 3 | | |
| | | | | | | bits) = 0 | | |
| 2 | (MSB) | | | | | | | |

| | |
|---|---|
| 3 | Current LBA |

| | |
|---|---|
| 4 | (LSB) |

| 5 | Number of Slots Available = 00h | |
|---|---|---|
| 6 | (MSB) | Length of Slot Table(s) = 0 |

| | |
|---|---|
| 7 | (LSB) |

The FAULT bit shall default to zero (0b), when a tray is blocked this bit shall be set to 1.

The CHANGER STATE field shall be cleared to zero.

The CURRENT SLOT shall be cleared to zero.

The MECHANISM STATE field (Error! Reference source not found.: codes in bold letter with light green background color) encodes the current operation of mechanism by the recoridn device. The default value of this field shall be set to 111b.

The loading means status can be reported in the mechanism state field as shown in table 4.

TABLE 5
Mechanism State Field and DoorOpen Status

| Mechanism | | DoorOpen | Implemen- |
|---|---|---|---|
| State | Definition | State | tation |
| 000_{B} | Idle | 0 | ✓ |
| 001_{B} | Playing (Audio or Data) | 0 | ✓ |
| 010_{B} | Tray stopped completely outside | 1 | ✓ |
| 011_{B} | Active with Initiator, | 0 | NA |
| | Composite or Other Ports in use | | |
| | (i.e. READ) | | |
| 100_{B} | Tray moving inside | 1 | ✓ |
| 101_{B} | Tray moving outside | 1 | ✓ |
| 110_{B} | Tray stopped and blocked | 1 | ✓ |
| 111_{B} | No State Information Available, | X | ✓ |
| | Default | | |

All others: Not supported by the Apache3.

The DOOROPEN bit=0, when a tray is closed. Otherwise this bit shall be set to one.

If not playing audio, the CURRENT LBA field shall be cleared to zero. Otherwise the value shall be calculated from current sub-channel.

The NUMBER OF SLOTS AVAILABLE shall be cleared to zero.

The LENGTH OF SLOT TABLE shall be cleared to zero.

When a medium is loaded by the recording device with the tray closed, a TOC shall be read automatically. This issues NewMediaEvent also.

Alternatively the changer state field can be used since it already comprises similar information and because this field is not used for loading means for single recording media.

Supported error reporting is defined in Table 6.

TABLE 6
Supported errors for MECHANISM STA TUS Command

| Error | | | Reference |
|---|---|---|---|
| Deferred Errors | | | Error! Reference source not found. |
| General Errors | | | Error! Reference source not found. |
| Sense | | | |
| Key | ASC | ASCQ | Description |
| 5 | 15 | 01 | ILLEGAL REQUEST, MECHANICAL |
| | | | POSITIONING ERROR |
| 5 | 1A | 00 | ILLEGAL REQUEST, PARAMETER LIST |
| | | | LENGTH ERROR |
| 5 | 20 | 00 | ILLEGAL REQUEST, INVALID COMMAND |
| | | | OPERATION CODE |
| 5 | 26 | 00 | ILLEGAL REQUEST, INVALID FIELD IN |
| | | | PARAMETER LIST |
| 6 | 28 | 00 | UNIT ATTENTION, NOT READY TO READY |
| | | | CHANGE, MEDIUM MAY HAVE CHANGED |
| 6 | 29 | 00 | UNIT ATTENTION, POWER ON, RESET, |
| | | | OR BUS DEVICE RESET OCCURRED |

Notes:
All values are in hexadecimal. When no value for SK is given, the error is applicable to multiple sense keys.

1. A recording device comprising a loading means arranged to load a single recording medium and comprising loading means status determining means for determining a loading means status,
characterized in that the loading means status determining means are operative to detect a loading means status representing a loading means operation of loading the recording medium

2. A recording device comprising a loading means arranged to load a single recording medium and comprising loading means status determining means for determining a loading means status,
characterized in that the loading means status determining means are operative to detect a loading means status representing a loading means operation of unloading the recording medium

3. A recording device comprising a loading means arranged to load a single recording medium and comprising loading means status determining means for determining a loading means status,
characterized in that the loading means status determining means are operative to detect loading means status representing a blocked loading means.

4. A recording device as claimed in claim 1,
characterized in that the loading means status comprises a progress indicator.

5. A recording device as claimed in claim 4,
characterized in that the progress indicator indicates a time duration until the loading means loading operation is complete

6. A recording device as claimed in claim 1,
characterized in that the recording device is operative to start a recording operation when a loading means status representing the loading means operation of loading the recording medium is detected

7. A recording device as claimed in claim 6,
characterized in that the recording device is operative to start a recording operation when the progress indicator associated with the loading means status representing the loading means operation of loading the recording medium reaches a predetermined value

8. A recording device as claimed in claim 7,
characterized in that the recording device further comprises a buffer with a buffer size and that the predetermined value of the progress indicator is determined by the buffer size.

9. A recording device as claimed in claim 1,
characterized in that the recording device is a recording device for recording real time information.

10. A recording device as claimed in claim 4,
characterized in that the recording device is operative to abort a recording operation when the loading means status representing the blocked loading means is detected.

11. A recording device as claimed in claim 10,
characterized in that the recording device is operative to issue a warning on a display device.

12. A recording device as claimed in claim 1,
characterized in that the loading means status determining means comprises loading means status reporting means accessible via an external interface of the recording device.

13. A recording device as claimed in claim 12
characterized in that the loading means status reposting means is operative to report a loading means status in a mechanism status header.

14. A recording device as claimed in claim 13
characterized in that the loading means status reposting means is operative to report a loading means status in a changer state field in the mechanism status header.

15. A recording device as claimed in claim 14
characterized in that the loading means status reposting means is operative to report a loading means status of 100b when the loading means is loading the recording medium, a loading means status of 101b when the loading means is unloading the recording medium, a loading means status of 110b when the loading means is blocked.

16. A method for recording information on a recording medium comprising the steps of inserting the recording medium in a loading means, operating the loading means and starting a recording operation,
characterized in that starting the recording operation coincides with operating the loading means.

17. A method for recording information on a recording medium as claimed in claim 16,
characterized in that a status of the loading means is determined before starting the recording.

18. A method for recording information on a recording medium as claimed in claim 17,
characterized in that the status comprises a progress indicator with a value, and that a predetermined value of the progress indicator must be reached before starting the recording.

19. A method for recording information an a recording medium as claimed in claim 18,
characterized in that the progress indicator indicates a time duration until the operating of the loading means is complete

20. A method for recording information an a recording medium as claimed in claim 19,
characterized in that before being recorded the information is stored in a buffer with a buffer size and that the predetermined value of the progress indication is determined by the buffer size.

21. A method for recording information an a recording medium as claimed in claim 16,
characterized in that the recording operation is aborted when the loading means status representing a blocked loading means is detected.
